(19) United States
(12) Patent Application Publication
(10) Pub. No.: US 2019/0339675 A1
(43) Pub. Date: Nov. 7, 2019

(54) RECORDING MEDIUM RECORDING PROGRAM UTILIZATION SUPPORT PROGRAM, INFORMATION PROCESSING DEVICE, AND PROGRAM UTILIZATION SUPPORT METHOD

(71) Applicant: FUJITSU LIMITED, Kawasaki-shi (JP)

(72) Inventors: Tomohiko Maeda, Setagaya (JP); Shusaku Nishiyama, Yokohama (JP); Toshikazu Furui, Kawasaki (JP)

(73) Assignee: FUJITSU LIMITED, Kawasaki-shi (JP)

(21) Appl. No.: 16/512,624

(22) Filed: Jul. 16, 2019

Related U.S. Application Data
(63) Continuation of application No. PCT/JP2017/002256, filed on Jan. 24, 2017.

(51) Int. Cl. G05B 19/418; G06F 9/445

(52) U.S. Cl. CPC G05B 19/4188; G05B 2219/32074; G06F 9/445

(57) ABSTRACT

A non-transitory computer-readable recording medium stores therein a program utilization support program that causes a computer to execute processing including: obtaining first data items included in production management data; specifying second data items which are used in execution of a production support program with reference to a storage that stores information indicating an execution status of the production support program; and determining whether the production support program is usable based on whether all of the second data items are included in the first data items.

### CROSS-REFERENCE TO RELATED APPLICATION

This application is a continuation application of International Application PCT/JP2017/002256 filed on Jan. 24, 2017 and designated the U.S., the entire contents of which are incorporated herein by reference.

### FIELD

The embodiment discussed herein is related to a program utilization support program, a program utilization support device, and a program utilization support method.

### BACKGROUND

A plant manager performs production efficiency improvement and production prediction on the basis of various production management data collected from production facilities in operation.

Japanese Laid-open Patent Publication No. 2016-66137, Japanese Laid-open Patent Publication No. 2010-218064, and Japanese Laid-open Patent Publication No. 2010-109887 are disclosed as related art.

### SUMMARY

According to an aspect of the embodiments, a non-transitory computer-readable recording medium stores therein a program utilization support program that causes a computer to execute processing including: obtaining first data items included in production management data; specifying second data items which are used in execution of a production support program with reference to a storage that stores information indicating an execution status of the production support program; and determining whether the production support program is usable based on whether all of the second data items are included in the first data items.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example and a processing example of a program utilization support device according to a first embodiment;

FIG. 2 is a view illustrating a configuration example of a production support system according to a second embodiment;

FIG. 3 is a diagram illustrating a hardware configuration example of a production support server;

FIG. 4 is a block diagram illustrating a configuration example of processing functions included in a production management server;

FIG. 5 is a view illustrating a data configuration example of a production management database accumulated on a production management server;

FIG. 6 is a block diagram illustrating a configuration example of processing functions included in a data accumulation server;

FIG. 7 is a view illustrating a data configuration example of a production management database accumulated on a data accumulation server;

FIG. 8 is a block diagram illustrating a configuration example of processing functions included in a production support server;

FIG. 9 is a view illustrating a data configuration example of a user management database;

FIG. 10 is a view illustrating a data configuration example of an application management database;

FIG. 11 is a diagram (part 1) illustrating a processing example of a production support program for visualizing progress records of a production process;

FIG. 12 is a diagram (part 2) illustrating a processing example of a production support program for visualizing progress records of a production process;

FIG. 13 is a diagram (part 1) illustrating a processing example of a production support program for visualizing a change in production quantity per unit time;

FIG. 14 is a diagram (part 2) illustrating a processing example of a production support program for visualizing a change in production quantity per unit time;

FIGS. 15A and 15B are diagrams illustrating a processing example of a production support program for correcting a deviation of a component mounting position;

FIG. 16 is a diagram illustrating an example of substitute items;

FIG. 17 is a flowchart illustrating a first processing example of a utilization support service;

FIGS. 18A to 18D are views illustrating an example of screen display on a terminal device in the first processing example;

FIG. 19 is a flowchart illustrating a second processing example of the utilization support service;

FIG. 20 is a view illustrating an example of screen display on a terminal device in the second processing example;

FIG. 21 is a diagram illustrating a configuration example of processing functions provided in a production support server according to a third embodiment;

FIG. 22 is a flowchart illustrating a processing example in a production support service;

FIG. 23 is a diagram illustrating a configuration example of processing functions provided in a production support server according to a fourth embodiment;

FIG. 24 is a flowchart illustrating a processing example in a developer support service; and

FIG. 25 is a view illustrating an example of screen display on a developer terminal by the developer support service.

### DESCRIPTION OF EMBODIMENTS

For example, application programs for supporting such operation of a manager may be in use. Execution of the application program would give the manager useful information for efficiency improvement and production prediction on the basis of the production management data.

Meanwhile, a medical treatment support device that outputs a data range recommended as an input data range to be calculated by a diagnosis support program may be provided. Furthermore, an information processing apparatus that searches for service attribute information related to the type that matches the type of service designated in a utilization request and that determines a service recommended to be used on the basis of evaluation information included in the searched service attribute information may be provided. Furthermore, a data processing method that determines whether input items needed for registration are satisfied at registration of data input from the image processing apparatus to a document management server may be provided.

Meanwhile, as described above, the production management data collected from the production facility is referred to at the time of execution of the application program that supports operation of a plant manager. Here, the production management data is data that depends on production facility, and thus, it is desirable that the application program used by the manager match the status of the production facility. However, there is a problem that an optimal application program matching the status of the production facility on the manager side may not be necessarily used.

For example, a program utilization support program, a program utilization support device, and a program utilization support method capable of determining whether a production support program is an appropriate program for a production facility may be provided.

Hereinafter, embodiments of the present invention will be described with reference to the drawings.

### First Embodiment

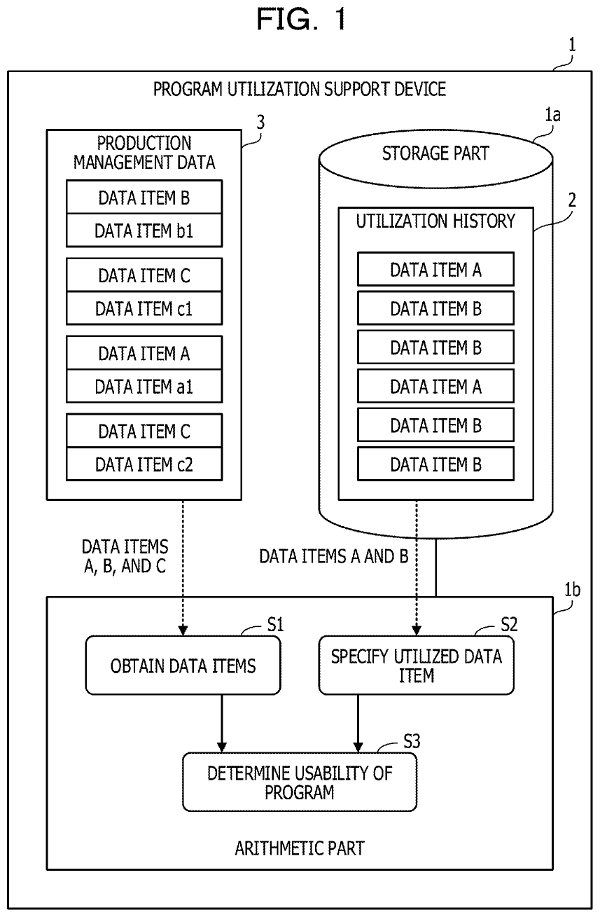

FIG. 1 is a diagram illustrating a configuration example and a processing example of a program utilization support device according to a first embodiment. A program utilization support device 1 executes processing for supporting the user's utilization of a production support program. Examples of the user include: a manager of a plant that produces products such as industrial products, components, food, or plants; or a planner of a production plan. The production support program is used by the user and thereby gives the user various support related to production, such as management of production processes, operation to streamline production, prediction of production, and creation of a production plan based on prediction.

Hereinafter, a user who receives a utilization support of the production support program from the program utilization support device 1 will be referred to as a “main user”.

The program utilization support device 1 includes a storage part 1a and an arithmetic part 1b. The storage part 1a is implemented as a storage region of a storage device included in the program utilization support device 1, for example. The arithmetic part 1b is implemented as a processor included in the program utilization support device 1, for example. In this case, the processor executes a predetermined program, thereby implementing processing of the arithmetic part 1b.

The storage part 1a stores information indicating an execution status of the production support program. This information indicates which data value of data items has been used (referred to) along with execution of a production support program when it is used by one or more users other than the main user.

Here, the data item is an item included in production management data. The production management data includes at least one set of data item and data value corresponding to the data item. The production management data is data obtained in a user's plant along with operation of the plant. In this case, the data item included in the production management data varies depending on the status of the production facility in the plant where the production management data is obtained.

In the example of FIG. 1, the storage part 1a stores a utilization history 2 of a data item at the time of execution of the production support program, as information indicating the execution status of the production support program. The utilization history 2 in the example of FIG. 1 has registered utilization of data items A, B, B, A, B, and B in this order in the execution of the production support program.

The arithmetic part 1b executes the following processing. The arithmetic part 1b obtains data items included in production management data 3 (step S1). The obtained production management data 3 is data corresponding to the main user, for example. In the example of FIG. 1, the production management data 3 includes a data value a1 corresponding to the data item A, a data value b1 corresponding to the data item B, and data values c1 and c2 corresponding to the data item C. In this case, the arithmetic part 1b obtains data items A, B, and C from the production management data 3.

In addition, the arithmetic part 1b refers to the storage part 1a and specifies a data item that has been used at execution of the production support program (step S2). In the example of FIG. 1, data items A and B are specified.

Next, the arithmetic part 1b determines whether the main user can use the production support program on the basis of whether all the data items specified in step S2 are included in the data items obtained in step S1 (step S3). Here, the data item specified in step S2 is estimated to be the minimum data item needed for execution of the production support program. Therefore, it is possible to estimate that the condition for using the production support program is satisfied when all the data items specified in step S2 are included in the data items obtained in step S1. For example, this state indicates high possibility of enabling the use the production support program without any problem by using the data items included in the production management data 3 currently obtained by the main user.

In the example of FIG. 1, the data items A and B specified in step S2 are all included in the data items A, B and C obtained in step S1. In this case, the arithmetic part 1b determines that the production support program can be used by the main user. In contrast, in a case where at least one of the data items specified in step S2 is not included in the data item obtained in step S1, the arithmetic part 1b determines that the production support program may not be used by the main user. The result of determination in step S3 is notified to the main user display information, for example.

According to the above processing, the program utilization support device 1 can determine whether the production support program is an appropriate program for the production facility of the main user. Accordingly, by notifying the determination result to the main user, it is possible to appropriately support the use of the production support program by the main user. The main user uses the production support program determined as usable, making it possible to achieve high efficiency in various tasks related to production.

Furthermore, it is conceivable, for example, to provide a method of preliminarily setting data items used at the time of execution of the production support program. However, the present embodiment specifies in step S2 data items actually used at execution of production support program rather than the preliminarily set data items. With this configuration, for example, in a case where the number of data items actually used is smaller than the number of preliminarily set data items, conditions for determining that the production support program can be used by the main user would be alleviated, increasing probability of determination that the program is usable. At this time, it is possible to avoid a determination that the production support program may not be used by the main user because the production management data 3 does not include data items that are not actually used. Therefore, usability of the production support program would be notified to more users having highly possibility of using the production support program without any trouble. Accordingly, the use of a production support program can be promoted.

### Second Embodiment

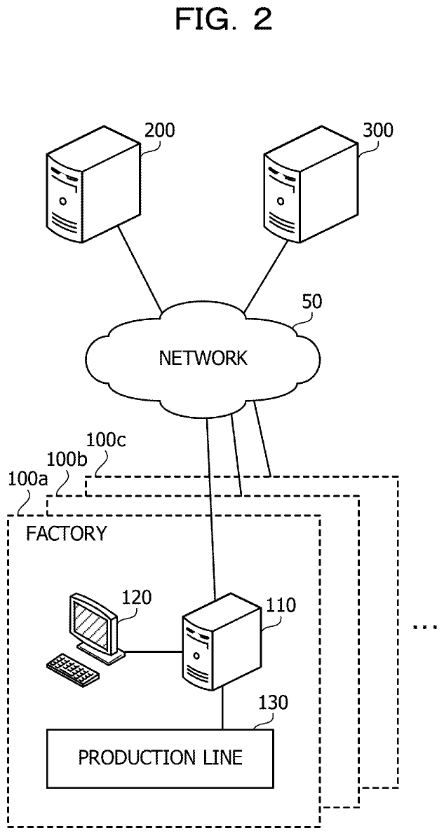

FIG. 2 is a view illustrating a configuration example of a production support system according to a second embodiment. The production support system illustrated in FIG. 2 is a system that provides a service for supporting production activities of a user at a plant when the user is a company or organization. FIG. 2 illustrates, as an example, plants 100a, 100b, 100c, . . . corresponding to individual users. Each of the plants 100a, 100b, 100c, . . . may be, for example, a plant that manufactures various industrial products and components, or a plant that produces plants, agricultural products, and food.

Each of the plants 100a, 100b, 100c, . . . includes a production management server 110, a terminal device 120, and a production line 130. The production management server 110 of each of the plants 100a, 100b, 100c, . . . is connected to a data accumulation server 200 and a production support server 300 via a network 50. The data accumulation server 200 and the production support server 300 are also communicable with each other via the network 50.

The production management server 110 manages the progress of production in the production line 130 in accordance with the data indicating the production plan. At this time, the production management server 110 accumulates various data measured in production in a production management database. In the following description, data accumulated in the production management database will be described as “production management data” in some cases. The production management data at least includes a pair formed of a measurement item and its measurement value, and indicates the progress of production or the state of a fabrication machine, for example.

The production management server 110 further includes a function of enabling the user to receive production support services provided from the production support server 300. The production support service is a service for supporting user's production activities, and examples of this include visualization of the production status, supplying statistical information in production activities, indication of problems or suggestion of improvement in production activities, and adjustment of production facilities. The production support service is implemented by an application program supplied from the production support server 300. Hereinafter, this application program will be referred to as a “production support program”.

For example, in the present embodiment, a production support program is executed in the production support server 300, and a result of this processing is supplied to the production management server 110. A production manager or a production planner of a plant uses the terminal device 120 and instructs the production support server 300 to execute the production support program via the production management server 110, and recognizes a result of processing via a display device, or the like on the terminal device 120.

Furthermore, the production management server 110 can receive, from the production support server 300, a utilization support service for supporting the use of the production support program. The utilization support service includes a service that notifies the user of which production support program can be supplied using production management data accumulated by the user and recommends the use of the program, for example. The production management server 110 has a function of uploading production management data accumulated in the production management server 110 to the data accumulation server 200 to achieve reception of the utilization support service.

The terminal device 120 is connected to the production management server 110 and operated by a user side operator such as a production manager or a production planner. The operator can receive a production support service or a utilization support service of a production support program via the terminal device 120.

The production line 130 produces a product under the control of the production management server 110. The production line 130 includes various sensors and transmits a detection value detected by the sensors in the course of production to the production management server 110, for example. The production line 130 is merely an example of production facility in a plant, and thus, a plant that can receive the production support service of the present embodiment is not limited to a plant that adopts a line production method.

The data accumulation server 200 collects production management data accumulated in each of the plants 100a, 100b, 100c, . . . and accumulates the data in a database. The data accumulation server 200 supplies the production management data accumulated in the database in response to a request from the production support server 300.

The data accumulation server 200 may be a server that provides a platform that enables various service providers to use production management data collected from a large number of plants, for example. In this case, the data accumulation server 200 includes an authentication function for connection with the production management server 110 of each of plants as a data collection source and with a server on the service provider side. The production support server 300 is positioned as one of the servers on the service provider side.

The production support server 300 executes a production support program and thereby provides the user a production support service. For example, the production support server 300 obtains production management data collected from the user, from the data accumulation server 200. The production support server 300 uses the obtained production management data and executes the production support program to which the user has requested for supply, and transmits the processing result to the production management server 110 of the user.

The production support server 300 also provides the user with a utilization support service of the production support program. For example, the production support server 300 provides the following service to a user who has not received the production support service. The production support server 300 selects a production support program recommended to the user. The production support server 300 also obtains, from the data accumulation server 200, production management data collected from the user. On the basis of the content of the obtained production management data, the production support server 300 determines whether the data preferable for the execution of the selected production support program has already been measured in the production management server 110 of the user.

In a case where the data has been measured, the production support server 300 notifies the user that the selected production support program is usable. In contrast, in a case where there is missing data for the use of the selected production support program, the production support server 300 notifies the user of the item of the missing data and further gives the user guidance that acquisition of data of the item would make it possible for the user to use a new production support program.

In this manner, the production support server 300 can give the user guidance to the production support program that can be used by the measurement items measured by the production management server 110 of the user, and can recommend the use of the program to the user. The production support server 300 can also give the user guidance to the production support program that can be used by increasing the measurement items, along with the measurement items to be increased, and can recommend the use of the program to the user. Furthermore, the production support server 300 can also give the user a recommendation to use another production support program when the user has already used the production support program.

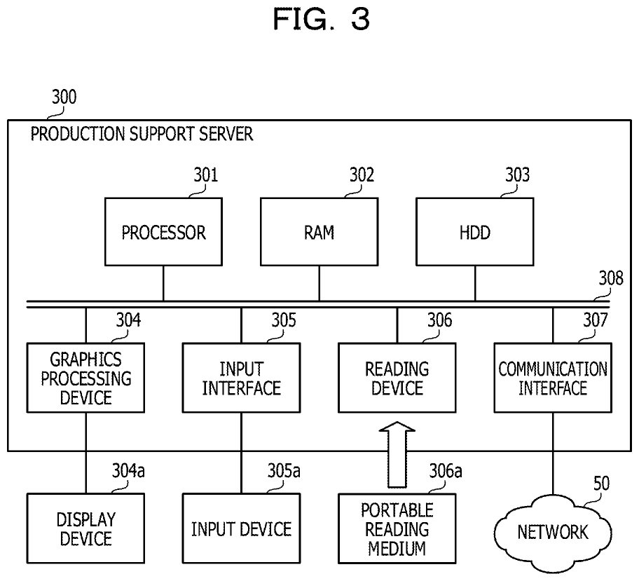

FIG. 3 is a diagram illustrating a hardware configuration example of a production support server. The production support server 300 according to the second embodiment is implemented as a computer as illustrated in FIG. 3, for example.

The processor 301 performs overall control of the production support server 300. The processor 301 may also be a multiprocessor. Examples of the processor 301 include: a central processing unit (CPU), a micro processing unit (MPU), a digital signal processor (DSP), an application specific integrated circuit (ASIC), or a programmable logic device (PLD). The processor 301 may be a combination of two or more elements of a CPU, an MPU, a DSP, an ASIC, and a PLD.

The processor 301 is connected with a random access memory (RAM) 302 and a plurality of peripheral devices via a bus 308.

The RAM 302 is used as a main storage device of the production support server 300. The RAM 302 temporarily stores at least a portion of an operating system (OS) program and an application program to be executed by the processor 301. The RAM 302 further stores various data needed for processing by the processor 301.

Examples of peripheral devices connected to the bus 308 include a hard disk drive (HDD) 303, a graphic processing device 304, an input interface 305, a reading device 306, and a communication interface 307.

The HDD 303 is used as an auxiliary storage device of the production support server 300. The HDD 303 stores an OS program, an application program, and various data. The auxiliary storage device can be implemented by another type of nonvolatile storage device such as a solid state drive (SSD).

The graphic processing device 304 is connected with a display device 304a. The graphic processing device 304 controls to display an image on the display device 304a in accordance with an instruction from the processor 301. Examples of the display device 304a include a liquid crystal display and an organic electroluminescence (EL) display.

The input interface 305 is connected with an input device 305a. The input interface 305 transmits a signal output from the input device 305a to the processor 301. Examples of the input device 305a include a keyboard and a pointing device. Examples of the pointing device include a touch panel, a tablet, a touch pad, and a track ball.

A portable recording medium 306a is removably attached to the reading device 306. The reading device 306 reads the data recorded on the portable recording medium 306a and transmits the read data to the processor 301. Examples of the portable recording medium 306a include an optical disc, a magneto-optical disc, and a semiconductor memory.

The communication interface 307 performs data transmission and reception with other devices such as the production management server 110 and the data accumulation server 200 via the network 50.

The processing function of the production support server 300 can be implemented with the above hardware configuration. Each of the production management server 110 and the data accumulation server 200 can also be implemented as a computer as illustrated in FIG. 3.

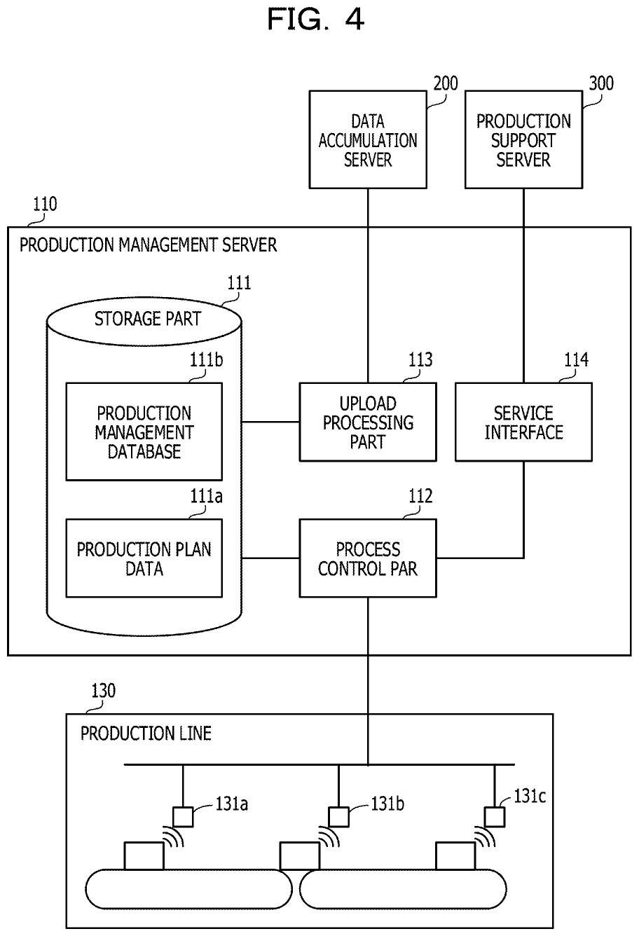

FIG. 4 is a block diagram illustrating a configuration example of processing functions provided in the production management server. The production management server 110 includes a storage part 111, a process control part 112, an upload processing part 113, and a service interface 114. The storage part 111 is implemented, for example, as a storage region of a storage device included in the production management server 110. The processing of the process control part 112, the upload processing part 113, and the service interface 114 are implemented by execution of a predetermined program by a processor provided in the production management server 110.

The storage part 111 stores production plan data 111a and a production management database 111b. The production plan data 111a is data used to control the progress of the production process in the production line 130. The production management database 111b accumulates production management data obtained from the production line 130. At least one of the production plan data 111a and the production management database 111b may be stored in a storage device externally connected to the production management server 110.

The process control part 112 controls the progress of the production process in the production line 130 on the basis of the production plan data 111a. Furthermore, the process control part 112 obtains production management data from the production line 130 and accumulates the data in the production management database 111b. As described above, the production management data is data measured in production.

For example, as illustrated in FIG. 4, the production line 130 is provided with sensors 131a, 131b, 131c, . . . for detecting the progress of production and the state of the fabrication machine. The process control part 112 obtains detection data from these sensors 131a, 131b, 131c, . . . and controls the progress of the process on the basis of the obtained detection data, and together with this, stores the obtained detection data as production management data in the production management database 111b. Examples of such detection data include a temperature detected by the temperature sensor, the current within the apparatus, the voltage value, the count value indicating the number of times of detection by a proximity sensor or a light section sensor, and a reading result and time of a barcode attached to the product or components carried in the production line 130.

In addition, the process control part 112 can perform predetermined calculation on the basis of the detection data obtained from the production line 130, and can store the calculation result as production management data in the production management database 111b. For example, the process control part 112 can calculate the number of products and the number of defects per hour in the manufacturing process on the basis of the completion time of a certain manufacturing process for a certain product, and can store the results in the production management database 111b. The process control part 112 can also calculate the positional deviation amount of the mount position or the variation of the position on the basis of the detection result of the mount position of the manufactured product in a certain manufacturing process, and can store the calculation result in the production management database 111b.

In this manner, detection data obtained from the production line 130 and the data calculated from the detection data are accumulated in the production management database 111b in each of plants. In the following description, the detection data value detected from the sensor and the value calculated from the detection data value will be referred to as a “measurement value”.

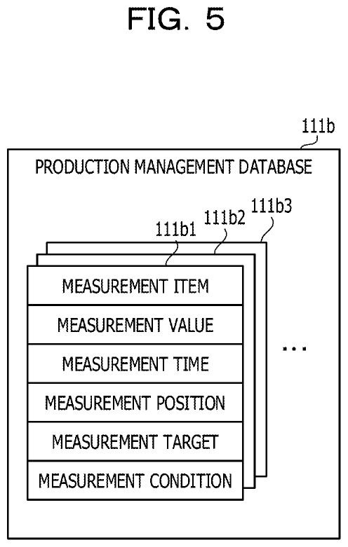

Here, FIG. 5 is a view illustrating a data configuration example of the production management database accumulated on the production management server. In each of records 111b1, 111b2, 111b3, . . . of the production management database 111b, measurement items, measurement values, measurement times, measurement positions, measurement targets, and measurement conditions are registered.

The measurement item indicates an information type of the measurement value. The measurement value is a value corresponding to the measurement item, and indicates, for example, a value detected by the sensor of the production line 130 or a value calculated on the basis of the detection value. The measurement time indicates the time of acquisition of the measurement value. The measurement position indicates the position on the production line 130 at which the measurement value was measured, and the measured process. In addition, in a case where a plurality of production lines 130 exists in a same plant, the measurement position may indicate identification information of the production line 130. The measurement target indicates information for identifying a product for which the measurement value is measured. For example, the measurement target indicates a product ID, a lot number, an order number, or the like. The measurement conditions indicate the conditions under which the measurement values were obtained. For example, the measurement conditions indicate the sampling period (acquisition frequency) of the measurement value, the resolution of the measurement value, or the like.

Hereinafter, description will return to FIG. 4.

The upload processing part 113 uploads the production management data accumulated in the production management database 111b to the data accumulation server 200. At this time, the upload processing part 113 converts the stored production management data into data of a predetermined format, for example, and uploads the data to the data accumulation server 200. For example, the production management data is converted into data in extensible markup language (XML) format or JavaScript Object Notation (JavaScript: registered trademark) (JSON) format data in which a pair of tag information and data value is described as text data.

The service interface 114 executes processing for receiving a production support service and a utilization support service of a production support program from the production support server 300. For example, the production support server 300 functions as a web server for providing these services. In this case, in the terminal device 120 connected to the production management server 110, a web browser operates, and the service interface 114 relays data transferred between the production support server 300 and the web browser of the terminal device 120. For example, the service interface 114 receives, from the production support server 300, data of a web page indicating the processing result of each of the above services, and transmits the data to the terminal device 120. With this operation, the processing result of the service is displayed on the web browser. The service interface 114 can also change control processing or setting of the production line 130 by the process control part 112 on the basis of data transmitted from the production support server 300 by processing of the production support program, for example.

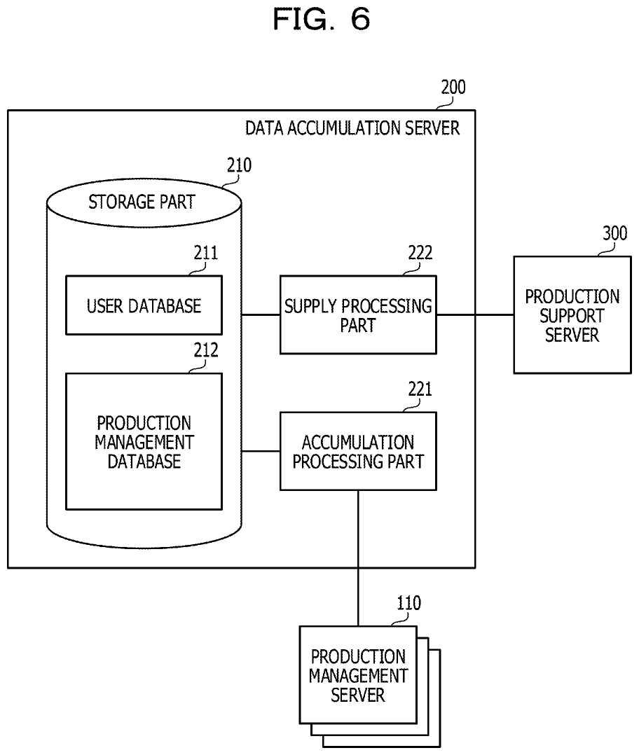

FIG. 6 is a block diagram illustrating a configuration example of processing functions provided in the data accumulation server. The data accumulation server 200 includes a storage part 210, an accumulation processing part 221, and a supply processing part 222. The storage part 210 is implemented, for example, as a storage region of a storage device provided in the data accumulation server 200. Processing of the accumulation processing part 221 and the supply processing part 222 is implemented by execution of a predetermined program by a processor included in the data accumulation server 200, for example.

The storage part 210 stores a user database 211 and a production management database 212. The user database 211 stores information needed to perform user authentication. The user mentioned here includes not only users who receive production support service from the production support server 300 but also users who can obtain production management data stored in the data accumulation server 200. For example, the user database 211 stores information used for user authentication when production management data is uploaded from the production management server 110 and stores information used for user authentication when production management data is requested from the production support server 300. The production management database 212 accumulates production management data collected from the production management server 110 of each of plants.

At least one of the user database 211 and the production management database 212 may be stored in a storage device externally connected to the data accumulation server 200.

The accumulation processing part 221 stores production management data uploaded from the production management server 110 of each of plants in the production management database 212. This enables integration of production management data accumulated locally at all plants into the production management database 212 of the data accumulation server 200. The accumulation processing part 221 refers to the user database 211 at the time of connection with each of the production management servers 110.

The supply processing part 222 reads out the production management data requested by the production support server 300 from the production management database 212 and transmits the data to the production support server 300. For example, the supply processing part 222 can perform: reception of a search key such as a user name and a measurement period from the production support server 300; extraction of production management data corresponding to the search key from the production management database 212; and transmission of the data to the production support server 300.

The supply processing part 222 refers to the user database 211 at the time of connection with the production support server 300. It is also possible, with the user database 211, to limit, for each of users, production management data that can be obtained by the production support server 300, or limit the range of data that can be obtained.

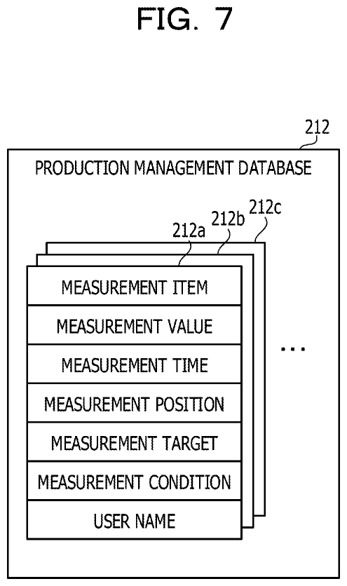

FIG. 7 is a view illustrating a data configuration example of a production management database accumulated on the data accumulation server. In each of the records 212a, 212b, 212c, . . . of the production management database 212, a user name is registered in addition to the data included in each of records of the production management database 111b accumulated in each of plants. The user name indicates the user as a transmission source of the data in the record.

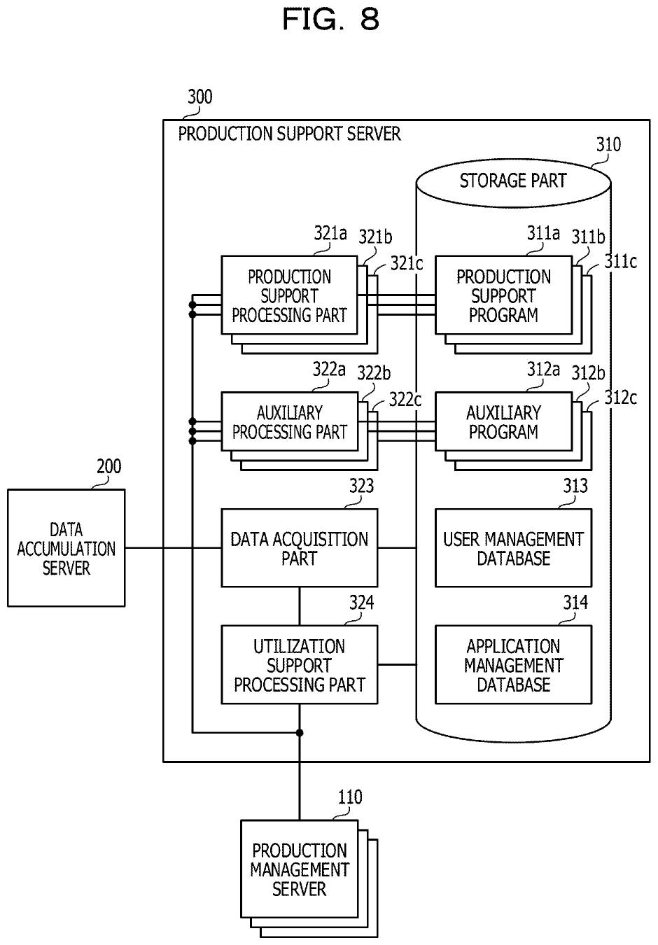

FIG. 8 is a block diagram illustrating a configuration example of processing functions provided in the production support server. The production support server 300 includes a storage part 310, production support processing parts 321a, 321b, 321c, . . . , auxiliary processing parts 322a, 322b, 322c, . . . , a data acquisition part 323, and a utilization support processing part 324.

The storage part 310 is implemented as a storage region of a storage device included in the production support server 300, such as the HDD 303 illustrated in FIG. 3, for example. The storage part 310 stores production support programs 311a, 311b, 311c, . . . , auxiliary programs 312a, 312b, 312c, . . . , a user management database 313, and an application management database 314.

The production support programs 311a, 311b, 311c, . . . are application programs for supplying a production support service. The auxiliary programs 312a, 312b, 312c, . . . are application programs that execute processing for assisting processing of the production support program. An example of this auxiliary processing is processing of creating production management data needed for the use of a production support program by using other production management data having different measurement items.

The user management database 313 includes data of a user who receives a production support service and a production support program used by the user that are registered in association with each other. Information for each of the production support programs 311a, 311b, 311c, . . . is registered in the application management database 314. For example, measurement items of production management information used (for example, referred to) at the time of execution of the production support program are registered in the application management database 314.

The processing of the production support processing parts 321a, 321b, 321c, . . . is implemented by execution of the production support programs 311a, 311b, 311c, . . . by the processor 301 of the production support server 300. For example, the production support processing parts 321a, 321b, 321c, . . . are activated by execution of the production support programs 311a, 311b, 311c, . . . by the processor 301.

For example, when the production support processing part 321a provides a production support service for a certain user, the production support processing part 321a obtains production management data corresponding to the user from the data accumulation server 200 via the data acquisition part 323. The production support processing part 321a uses the obtained production management data and executes processing for supporting the user's production activities, and transmits the processing result to the production management server 110 corresponding to the user.

The processing of the auxiliary processing parts 322a, 322b, 322c, . . . is implemented by execution of the auxiliary programs 312a, 312b, 312c, . . . by the processor 301 of the production support server 300. For example, the auxiliary processing parts 322a, 322b, 322c, . . . are activated by execution of the auxiliary programs 312a, 312b, 312c, . . . by the processor 301.

The processing of the data acquisition part 323 and the utilization support processing part 324 is implemented, for example, by execution of a predetermined program by the processor 301 of the production support server 300.

The data acquisition part 323 obtains, from the data accumulation server 200, production management data needed for the execution of the production support program. For example, the data acquisition part 323 transmits a search key such as a user name and a measurement period to the data accumulation server 200 to request a search, and thereby obtains data of a record corresponding to the search key from production management database 212 of the data accumulation server 200.

The utilization support processing part 324 executes processing of providing a utilization support service of the production support program. For example, the utilization support processing part 324 selects a user together with a production support program to be recommended to the user. The utilization support processing part 324 obtains production management data corresponding to the selected user from the data accumulation server 200 via the data acquisition part 323, and specifies measurement items measured by the production management server 110 of the user on the basis the obtained data. Together with this, the utilization support processing part 324 extracts, from the application management database 314, preferable measurement items to be used at execution of the selected production support program. Subsequently, the utilization support processing part 324 determines whether the specified measurement items include all the preferable measurement items.

In a case where the specified measurement items include all the preferable measurement items, the utilization support processing part 324 notifies the user that the selected production support program can be used. In contrast, in a case where there is a missing measurement item for the use of the selected production support program, the utilization support processing part 324 notifies the user of the missing measurement item. The utilization support processing part 324 gives the user guidance that performing new measurement of the missing measurement item would make it possible for the user to use the selected production support program.

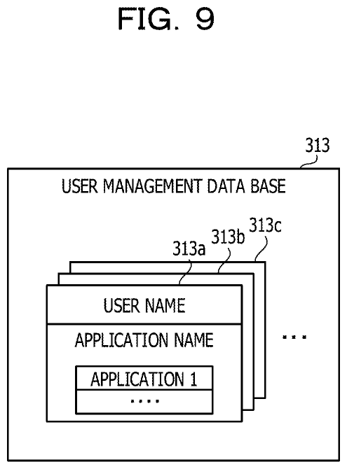

FIG. 9 is a view illustrating a data configuration example of the user management database. The user management database 313 includes records 313a, 313b, 313c, . . . for each of users. In each of the records 313a, 313b, 313c, . . . , a user name identifying a user and an application name indicating a production support program usable to the user according to a utilization request from the user are registered.

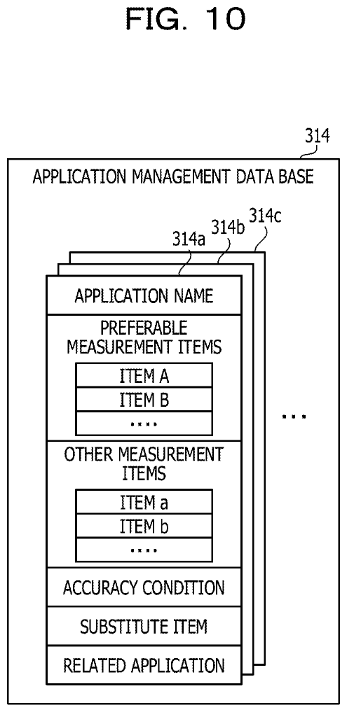

FIG. 10 is a view illustrating a data configuration example of the application management database. The application management database 314 includes records 314a, 314b, 314c, . . . separately for each of production support programs. In each of the records 314a, 314b, 314c, . . . , an application name, preferable measurement items, other measurement items, an accuracy condition, a substitute item, and a related application are registered.

The application name is identification information that identifies the production support program. The preferable measurement items indicate the measurement items preferable for the execution of the production support program. The other measurement items indicate measurement items not included in the preferable measurement item among the measurement items usable at the time of execution of the production support program. A plurality of measurement items can be registered for each of the preferable measurement items and other measurement items.

The accuracy condition indicates the condition for the accuracy of the measurement value usable at the execution of the production support program for at least one of the measurement items registered as preferable measurement item or other measurement items. For example, the measurement item having a registered accuracy condition is not usable at the execution of the production support program unless the measurement value satisfies the accuracy condition. The accuracy referred to here is an index indicating the correctness and reliability of the measurement value. Examples of the accuracy condition to be registered include conditions such as measurement frequency or variation of measurement values.

The substitute item indicates other measurement items usable instead of the measurement item designated as a preferable measurement item. The related application indicates an auxiliary program related to the production support program. An example the related application to be registered is an auxiliary program capable of creating the measurement value of the preferable measurement item by calculation based on the measurement value of the other measurement items.

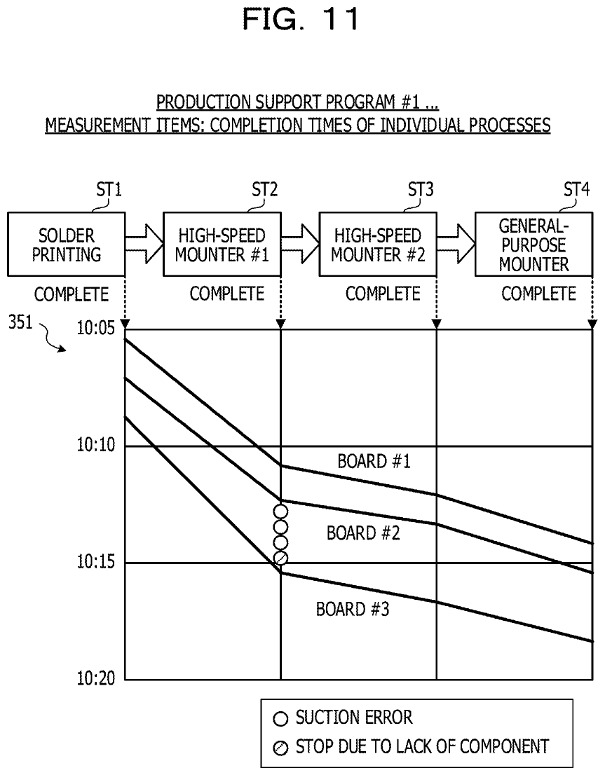

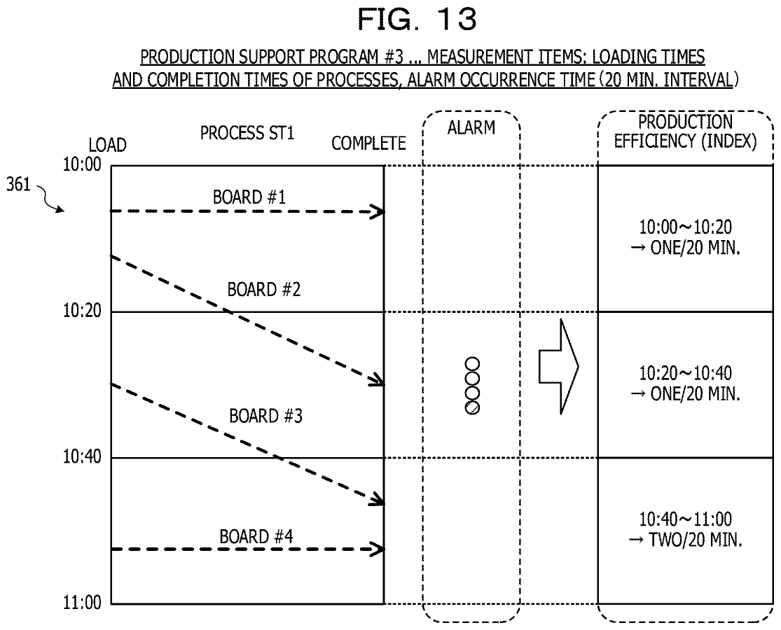

Next, an example of a production support service implemented by the production support program will be described with reference to FIGS. 11 to 15B. Furthermore, FIGS. 13 to 15B also illustrate accuracy conditions corresponding to the measurement items.

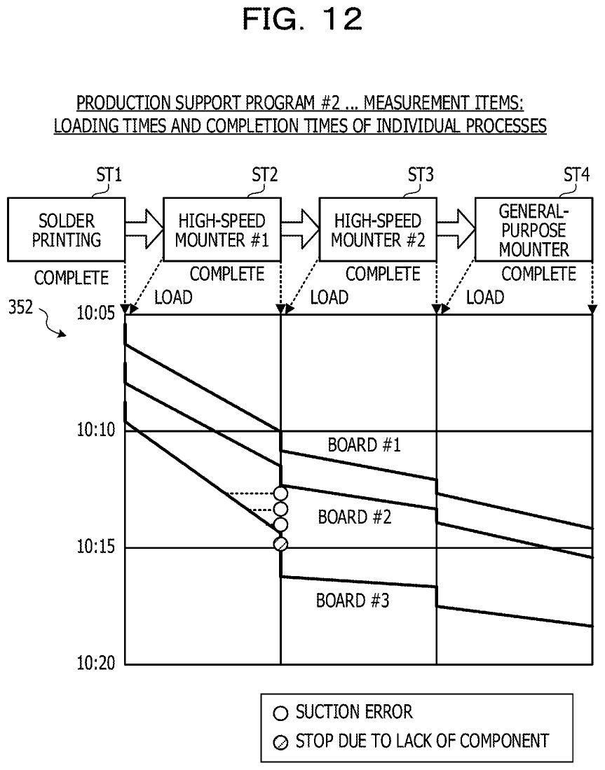

First, FIGS. 11 and 12 are diagrams illustrating a processing example of a production support program for visualizing progress records of a production process. FIGS. 11 and 12 is an example of an assumable case where the production support program is applied to a component mounting process on a printed circuit board. Here, this mounting process includes processes ST1 to ST4. The process ST1 is a process of performing solder printing on the board. process ST2 is a process of mounting a component on a board using a high speed mounter #1. The process ST3 is a process of mounting a component on a board using a high speed mounter #2. process ST4 is a process of mounting a component on a board using a general purpose mounter.

Here, FIG. 11 is a processing example of a production support program #1, and FIG. 12 is a processing example of a production support program #2. Here, the production support program #2 is a program having a same field or type as the production support program #1, while having more functions than the production support program #1. For example, the production support program #2 corresponds to an advanced version of the production support program #1.

As illustrated in FIG. 11, completion time of each of processes ST1 to ST4 for each of components is used as a measurement item by the execution of the production support program #1, and a graph 351 illustrated in FIG. 11 is displayed on the terminal device 120 on the basis of the completion time. The graph 351 illustrates the progress of the processes for each of the boards #1 to #3, in which the vertical axis illustrates lapse of time, and the horizontal axis illustrates the progress of the processes. Points of the completion times of the individual processes for the same board are connected by a straight line.

This graph 351 indicates that the smaller the inclination of the straight line, the faster the progress of the process for the corresponding board meaning higher the production efficiency. Accordingly, the operator of the terminal device 120 can visually recognize the production efficiency in the mounting process by visually checking the graph 351.

Furthermore, here is an exemplary case, as illustrated in FIG. 11, of detecting in process ST2 an alarm indicating a suction error and an alarm indicating a stop due to lack of component. The operator can estimate the board having occurrence of the alarm by matching the alarm occurrence time with the straight line on the graph 351.

In contrast, as illustrated in FIG. 12, the loading times of the processes ST1 to ST4 for each of components are further used as measurement items at execution of the production support program #2. Subsequently, a graph 352 illustrated in FIG. 12 is displayed on the terminal device 120 on the basis of the loading time and the completion time of each of the processes. In the graph 352, the completion time of a certain process, the loading time of the next process, and the completion time of the same process are sequentially connected by a straight line for a same board.

According to this graph 352, the time between the completion time of one process and the loading time of the next process appears as a waiting time. This enables the operator to recognize the length difference of the waiting time in addition to the production efficiency in each of processes by the slope of the straight line. This further enables the operator to confirm whether an alarm occurred during the loading of the process or during the waiting time. In the example of FIG. 12, the operator can recognize that an alarm has occurred in the waiting time between the process ST1 and the process ST2 for the board #3. In this manner, the service using the production support program #2 can visualize the progress of the production process more finely than the service using the production support program #1.

Here, the completion time of each of processes is registered as a preferable measurement item in the record corresponding to the production support program #1 among the records of the application management database 314. In contrast, the loading time and the completion time of each of processes are registered as the preferable measurement items in the record corresponding to the production support program #2. As illustrated in examples of FIGS. 11 and 12, it is possible to provide a production support service that can support production activities more finely in production support programs having more preferable measurement items.

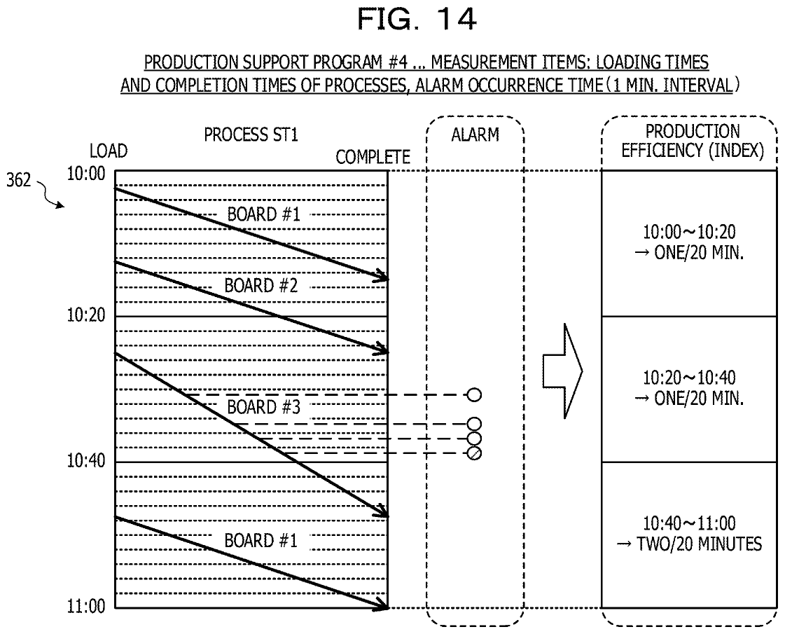

FIGS. 13 and 14 are diagrams illustrating a processing example of a production support program for visualizing a change in production quantity per unit time. FIGS. 13 and 14 illustrate exemplary cases of visualizing the number of boards loaded onto the above-described process ST1 and the number of boards on which mounting of component has been completed in the process ST1. FIG. 13 is a processing example of a production support program #3, and FIG. 14 is a processing example of a production support program #4. The production support program #4 corresponds to the advanced version of the production support program #2.

At execution of any of the production support programs #3 and #4, the loading time to the process ST1 and the completion time of the process ST1 for each of boards and the alarm occurrence time are used as measurement items. For example, the loading time, completion time, and alarm occurrence time are registered as preferable measurement items in the record corresponding to the production support programs #3 and #4 among the records of the application management database 314.

The difference is, however, in that while the acquisition interval of measurement values corresponding to each of measurement items is allowed to be 20 minutes or less in processing of production support program #3, the preferable acquisition interval is one minute or less in the processing of production support program #4. For example, a condition that the acquisition interval of each of the loading time, completion time and alarm occurrence time need to be 20 minutes or less is registered as an accuracy condition for the record corresponding to the production support program #3 among the records of the application management database 314. Furthermore, a condition that the acquisition interval of each of the loading time, completion time and alarm occurrence time is preferably one minute or less is registered as an accuracy condition for the record corresponding to the production support program #4. In this manner, although the same preferable measurement items are set for both the production support program #3 and the production support program #4, the accuracy conditions set for each of the preferable measurement items are different.

As illustrated in FIG. 13, with execution of the production support program #3, a graph 361 illustrating the progress of the boards #1 to #4 in the process ST1 is displayed on the terminal device 120 on the basis of the loading time and the completion time corresponding to each of the boards #1 to #4. Together with this, on the basis of the alarm occurrence time corresponding to each of the boards #1 to #4, a marker indicating occurrence of an alarm is displayed in association with a time zone of every 20 minutes in the graph 361. Furthermore, the process completion number per 20 minutes is calculated as an index indicating production efficiency, and is displayed in association with the time zone of every 20 minutes in the graph 361. For example, an index of 1 per 20 minutes is calculated for the time zone from 10:00 to 10:20.

In contrast, as illustrated in FIG. 14, with execution of the production support program #4, a graph 362 illustrating the progress of the boards #1 to #4 in the process ST1 is displayed on the terminal device 120 on the basis of the loading time and the completion time corresponding to each of the boards #1 to #4. Together with this, on the basis of the alarm occurrence time corresponding to each of the boards #1 to #4, a marker indicating occurrence of an alarm is displayed in association with a time zone of every minute in the graph 362. Furthermore, the process completion number per 20 minutes is calculated as an index indicating production efficiency, and is displayed in association with the time zone of every 20 minutes in the graph 362.

According to the display information of FIG. 13, the operator can visually recognize that an alarm has occurred four times in a time zone from 10:20 to 10:30 . However, in this time zone, since both the board #2 and the board #3 have been loaded onto the process ST1, the operator may not determine which of the component mounting operations of the board #2 and the board #3 encountered an alarm. In comparison, according to the display information of FIG. 14, the position of the marker indicating the occurrence of the alarm is displayed with a finer resolution of one minute. This enables the operator to determine that an alarm has occurred in the component mounting operation of the board #3.

In this manner, even when the preferable measurement items used at the time of execution of the production support program are the same, production support services with different levels of support for production activities are provided due to differences in accuracy conditions.

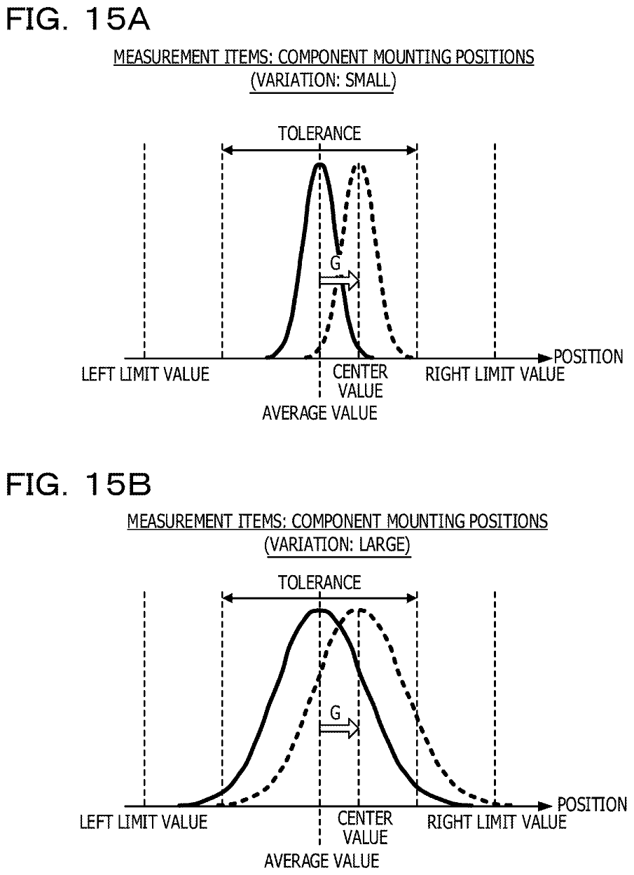

FIGS. 15A and 15B are diagrams illustrating a processing example of a production support program for correcting a deviation of a component mounting position. FIGS. 15A and 15B are as an example where the production support program #5 is applied to the component mounting process onto a board by a predetermined mounter. At execution of the production support program #5, the component mounting position on the board is used as a preferable measurement item. For example, the component mounting position is registered as a preferable measurement item in the record corresponding to the production support program #5 among the records of the application management database 314. In FIGS. 15A and 15B, the component mounting position is represented as a coordinate value in the left-right direction on the board, and this coordinate value would be a larger value as it goes to the right.

With the execution of the production support program #5, the terminal device 120 displays a graph illustrating the distribution of the mounting position of each of components loaded onto the mounting process in a predetermined time zone. Subsequently, an average value of the mounting positions is calculated, and a deviation amount G indicating how much the average value deviates from a predetermined reference value is calculated. This reference value indicates an ideal reference position when the component is mounted on the board, and the deviation amount G indicates how much the average mounting position of the component in the actual mounting process deviates from the ideal reference position.

With recognition of the calculated deviation amount G, the operator of the terminal device 120 can change the control data of the production line 130 so that the component mounting position on the board is corrected by deviation amount G. Alternatively, control data of the production line 130 may be automatically corrected by the execution of the production support program #5.

FIG. 15A illustrates an example of a graph in a case where the variation in the mounting position is small. FIG. 15B illustrates an example of a graph in a case where the variation is large. There is a limit to the range on the board in which components can be mounted. Each of FIGS. 15A and 15B illustrates a left limit value indicating a left limit position and a right limit value indicating a right limit position.

In a case where the variation of the mounting position is relatively small as illustrated in FIG. 15A, moving the mounting position by the deviation amount G would be able to allow the coordinates of the mounting position measured after the movement to fall within a range between the left limit value and the right limit value. However, even in a case where the calculated deviation amount G is the same as in the case of FIG. 15A, moving the mounting position by the deviation amount G in a case where the variation of the mounting position is large as illustrated in FIG. 15B would cause the mounting position measured after the movement to exceed the mountable range in some cases. In the example of FIG. 15B, the coordinates of the mounting position exceed the right limit value after the movement of the mounting position.

For this reason, the measurement value of the mounting position of the component to be used at execution of the production support program #5 need to have the variation being a certain value or less. Accordingly, in the record corresponding to the production support program #5 among the records of the application management database 314, the condition that the index indicating the variation is to be a predetermined value or less is registered as the accuracy condition for the component mounting position. For example, a tolerance centering on the average value of the mounting position of the measured component is set in FIGS. 15A and 15B. Additionally, the condition that the variance of the measurement values of the mounting position is to fall within the tolerance is registered as the accuracy condition for the component mounting position.

Here, in the example of FIGS. 13 and 14 described above, a condition related to the measurement condition of the measurement value acquisition interval (acquisition frequency) is set as the accuracy condition corresponding to the measurement item. Such measurement conditions are set as measurement conditions in the records of the production management database 212. Therefore, the utilization support processing part 324 may determine whether the measurement condition extracted from the record corresponding to the user satisfies the accuracy condition and thereby may determine whether the measurement value of the measurement item can be used at execution of the production support program.

In contrast, in the example of FIGS. 15A and 15B, the variation of the measurement value of the measurement item is set as the accuracy condition. In such a case, the utilization support processing part 324 may determine whether the measurement value of this measurement item can be used at the time of execution of the production support program as follows. For example, the utilization support processing part 324 calculates the variation of the measurement values extracted from the plurality of records corresponding to the user, and makes determination by checking whether the calculated variation satisfies the accuracy condition.

Next, substitute items registered in the application management database 314 will be described.

As described above, when determining whether a certain user can use a production support program, the utilization support processing part 324 obtains production management data corresponding to the user, from the data accumulation server 200. Subsequently, the utilization support processing part 324 specifies the measurement item measured by the production management server 110 of the user on the basis of the obtained data. Together with this, the utilization support processing part 324 extracts the preferable measurement items for the production support program from the application management database 314, and determines whether the specified measurement items include all the preferable measurement items.

Here, even in a case where there is a measurement item that is missing for the use of the production support program, the measurement value of the measurement item may be substituted by a measurement value of another measurement item having substantially the same measurement content. In addition, when such a substitutable measurement item has been measured by the production management server 110 of the user, the utilization support processing part 324 can determine that the user can use the production support program.

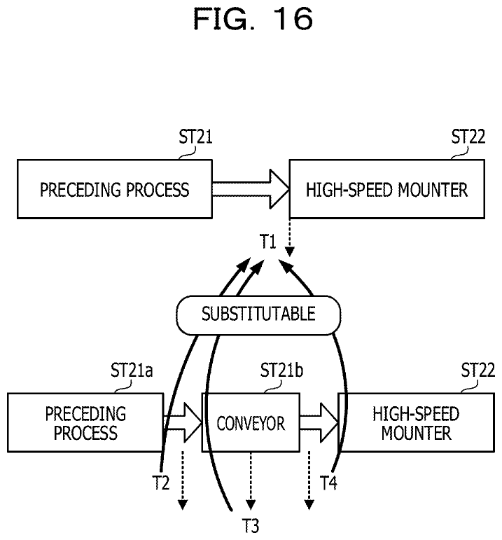

FIG. 16 is a diagram illustrating an example of a substitute item. FIG. 16 is an assumable case having processes ST21 and ST22 included in the component mounting process onto the printed circuit board. The process ST21 is a preceding process for the component mounting process. The process ST22 is a component mounting process using a high speed mounter.

For example, here is an assumable case where the loading time T1 has not been measured with the production management server 110 of a certain user although the loading time T1 of the board for the process ST22 has been set as a preferable measurement item corresponding to a certain production support program. Meanwhile, as illustrated on the lower side of FIG. 16, the process ST21 includes a preceding process ST21a and a process ST21b including conveyance of the board to the high speed mounter by a conveyor. In addition, the production management server 110 of the user is supposed to have measured, as measurement items, a completion time T2 of process ST21a, a passage time T3 of the board at the predetermined position in process ST21b, and a set completion time T4 of the board by the conveyor in the process ST21b.

In this case, when the conveyance time of the board by the transfer conveyor in process ST21b is sufficiently shorter than the time taken for mounting the components by the high speed mounter in the process ST22, for example, the loading time T1 can be substituted by any of the completion time T2, the passage time T3, or the set completion time T4.

Next, processing in the utilization support service of the production support program will be described using a flowchart.

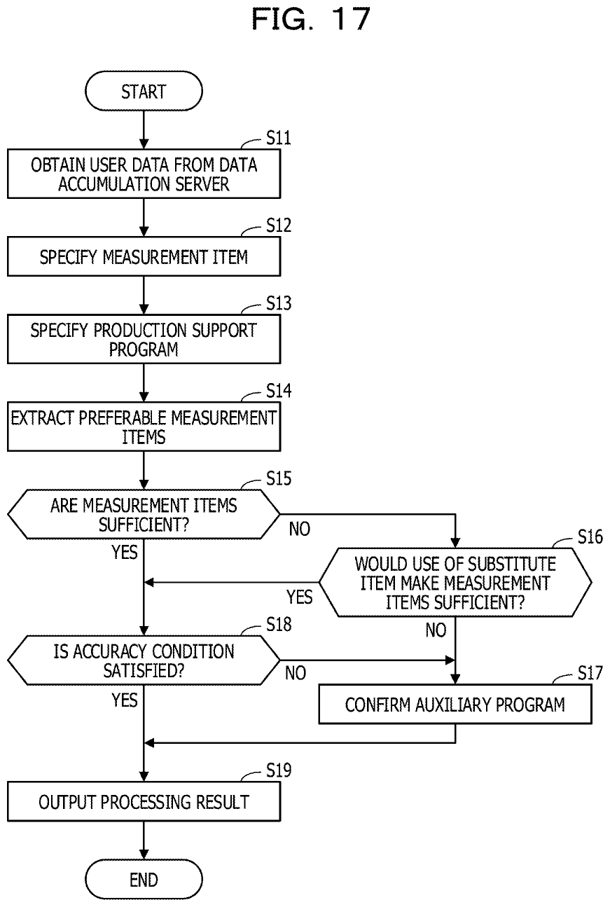

FIG. 17 is a flowchart illustrating first processing example of the utilization support service. The first processing example illustrates processing in a utilization support service that provides the user with information based on the determination result of determining whether a specific production support program is usable by a specific user.

[Step S11]

The utilization support processing part 324 of the production support server 300 selects a user to which a utilization support service is to be provided. Subsequently, the utilization support processing part 324 obtains production management data corresponding to the selected user from the data accumulation server 200 via the data acquisition part 323. For example, the utilization support processing part 324 notifies the user name of the user selected as a search key. The utilization support processing part 324 transmits the notified user name as a search key to the data accumulation server 200, and requests a search of the production management database 212. In response to this request, a record corresponding to the user is read out from the production management database 212 and transmitted to the production support server 300. The data acquisition part 323 receives the data of the transmitted record and passes the data to the utilization support processing part 324.

[Step S12]

The utilization support processing part 324 specifies the measurement item measured by the production management server 110 of the user on the basis of the obtained production management data. For example, the utilization support processing part 324 extracts the measurement item set in the obtained record.

[Step S13]

The utilization support processing part 324 specifies one production support program to be recommended to the user. For example, in a case where the user has not received the production support service, the utilization support processing part 324 selects a production support program related to the business type and usage of the user. Moreover, in a case where the user has already received the production support service, the following processing would be executed, for example. The utilization support processing part 324 refers to the user management database 313 and extracts one production support program being used by the user. Subsequently, the utilization support processing part 324 specifies another production support program related to the extracted production support program, for example, a production support program that is an advanced version of the extracted production support program, as a production support program to be recommended to the user.

In this step S13, for example, the production support program may be designated from the user side. In this case, the user can inquire of the production support server 300 about whether the specific production support program can be used by using the measurement value of the measurement item currently being measured.

[Step S14]

The utilization support processing part 324 extracts, from the application management database 314, the preferable measurement items set for the production support program specified in step S13.

[Step S15]

The utilization support processing part 324 checks matching between the preferable measurement items extracted in step S14 with the measurement items specified in step S12 and determines whether the user's measurement items are sufficient.

In the case where the extracted preferable measurement items are all included in the measurement items specified in step S12, the utilization support processing part 324 determines that the measurement items are sufficient, and executes the processing of step S18. In contrast, in a case where there is an extracted preferable measurement item not included in the measurement item specified in step S12, the utilization support processing part 324 determines that the measurement items are not sufficient, and executes the processing of step S16.

[Step S16]

The utilization support processing part 324 extracts, from the application management database 314, the substitute item set for the production support program specified in step S13. Subsequently, the utilization support processing part 324 determines whether the following conditions are satisfied.

The utilization support processing part 324 first determines whether the substitute item has been extracted from the application management database 314. In a case where the substitute item has been successfully extracted, the utilization support processing part 324 specifies the preferable measurement items not included in the measurement items specified in step S12 among the preferable measurement items, and then determines whether the substitute items have been set for all the specified preferable measurement items. In a case where the substitute items have been set, the utilization support processing part 324 determines whether all of the set substitute items are included in the measurement items specified in step S12.

In a case where all the above conditions are satisfied, the utilization support processing part 324 determines that the measurement items are sufficient due to the use of the substitute item, and executes the processing of step S18. In contrast, in a case where at least one of the above conditions is not satisfied, the utilization support processing part 324 determines that the measurement items are insufficient, and executes the processing of step S17.

[Step S17]

The utilization support processing part 324 extracts, from the application management database 314, the related application set for the production support program specified in step S13. The utilization support processing part 324 confirms whether the program extracted as a related application includes an auxiliary program that can create the measurement values of the preferable measurement items determined as insufficient in the program from the measurement values of the other measurement items specified in step S12. In a case where it is determined in this processing that the corresponding auxiliary program is included, the information indicating the auxiliary program will be included in the processing result to be output in step S19.

[Step S18]

The utilization support processing part 324 extracts, from the application management database 314, the accuracy condition set for the production support program specified in step S13. Subsequently, the utilization support processing part 324 determines whether the following conditions are satisfied.

The utilization support processing part 324 first determines whether the accuracy condition has been successfully extracted from the application management database 314. In a case where the accuracy condition has been successfully extracted, the utilization support processing part 324 determines whether the measurement values of the user corresponding to all the preferable measurement items for which the accuracy condition is set satisfy the accuracy condition. In a case where it is determined in step S16 that there is a substitute item corresponding to the preferable measurement item, it is also determined whether the measurement value of the user corresponding to the substitute item satisfies the accuracy condition.

In a case where all the above conditions are satisfied, the utilization support processing part 324 determines that the production support program specified in step S13 can be used by the user, and executes the processing of step S19. In contrast, in a case where at least one of the above conditions is not satisfied, the utilization support processing part 324 executes the processing of step S17.

Note that the accuracy of the measurement value can be or may not be obtained from the measurement condition of the record obtained in step S11 depending on the case. For example, in the case of the production support program #4 illustrated in FIG. 14, the preferable measurement items are the process loading time and completion time, and the alarm occurrence time, while the accuracy condition is that the acquisition interval of these measurement values is one minute or less. In this case, when the acquisition interval of each of preferable measurement items is set as the measurement condition of the record obtained in step S11, the utilization support processing part 324 can determine whether the accuracy condition is satisfied on the basis of the set acquisition interval.

In contrast, for example, in the case of the production support program #5 illustrated in FIGS. 15A and 15B, the preferable measurement item is the component mounting position, and the accuracy condition is that an index (here, variance) indicating the variation of the mounting position is a certain value or less. In this case, when the variance of the mounting position has not been set in the measurement condition of the record obtained in step S11, the utilization support processing part 324 calculates the variance of the measurement value of each of obtained records and determines whether the calculated variance satisfies the accuracy condition.

[Step S19]

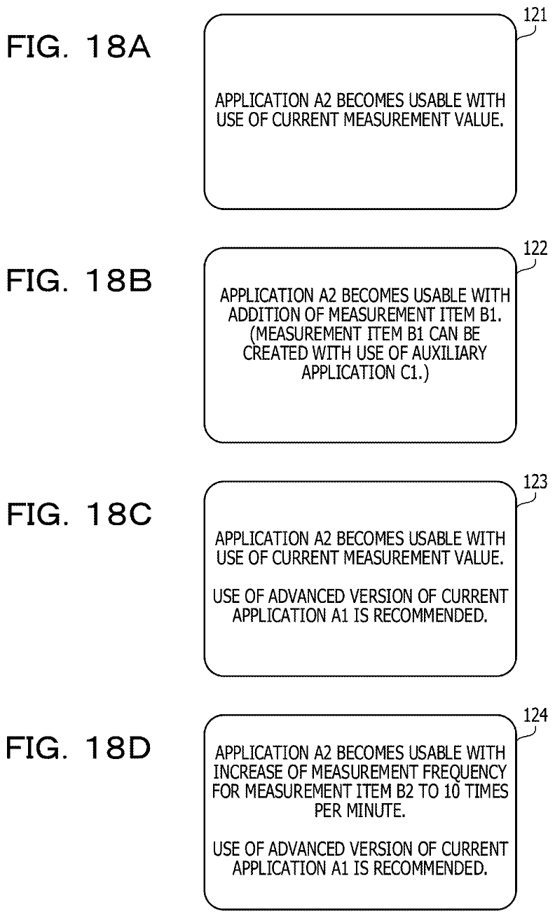

The utilization support processing part 324 transmits the processing result of the above processing to the production management server 110 of the user, and controls to display the processing result on the terminal device 120. Here, an example of the processing result is illustrated in FIGS. 18A to 18D.

FIGS. 18A to 18D are views illustrating an example of screen display on a terminal device in the first processing example. FIGS. 18A and 18B illustrate examples of screens presented to a user who has not received the production support service.

A screen 121 illustrated in FIG. 18A is an example of a screen to be displayed as a result of determination of step S18 in FIG. 17 that the user can use the production support program “application A2”. With this screen 121, the utilization support processing part 324 can guide the user that the production support program can be used using the measurement value currently measured, and can recommend the use of the program. For example, the utilization support processing part 324 can present the user with a production support program that matches the environment of the user's production facility and production system.

A screen 122 illustrated in FIG. 18B is an example of a screen to be displayed as a result of determination of step S15 in FIG. 17 that the measurement items B1 are not sufficient and after extraction of an auxiliary program of “auxiliary application Cl” for creating the measurement item B1 in step S17. With this screen 122, the utilization support processing part 324 can guide the user that the production support program can be used by newly measuring the measurement item B1, and can recommend the use of the program. The utilization support processing part 324 can further guide the user to the auxiliary program for creating the measurement value of the insufficient measurement item B1, and can recommend the use of the production support program described above.

Here, in the processing for creating the information as illustrated in FIGS. 18A and 18B, the determination is performed using the accuracy condition and the substitute item as well. This may improve the correctness of the information to supply.

In addition, the production support server 300 guides the user to the usable production support program and the method for making the production support program usable, making it possible to promote the use of the production support program. Here, the production support server 300 analyzes a huge amount of production management data accumulated on the user side, and supplies the information obtained as a result of the analysis to the user. With this configuration, a provider of the production support service can easily recommend the use of the production support program to many users on the basis of a huge amount of data difficult to be analyzed manually. Accordingly, the use of a production support program can be promoted with low cost.

Next, each of FIGS. 18C and 18D is a case where the user is currently using the production support program of “application A1”, and the production support program of “application A2” as an advanced version of the “application A1” has been specified in step S13 of FIG. 17.

A screen 123 illustrated in FIG. 18C is an example of a screen to be displayed as a result of determination of step S18 in FIG. 17 that the user can use the new production support program “application A2”. With this screen 123, the utilization support processing part 324 can guide the user that the new production support program can be used, and can recommend the use of the program.

A screen 124 illustrated in FIG. 18D is an example of a screen to be displayed as a result of determination in step S18 of FIG. 17 that the measurement value of the measurement item B2, which is a preferable measurement item, does not satisfy the accuracy condition that the measurement frequency is 10 times per minute or more. With this screen 124, the utilization support processing part 324 can guide the user that the new production support program can be used by increasing the measurement frequency of the measurement item B2, and can recommend the use of the program.

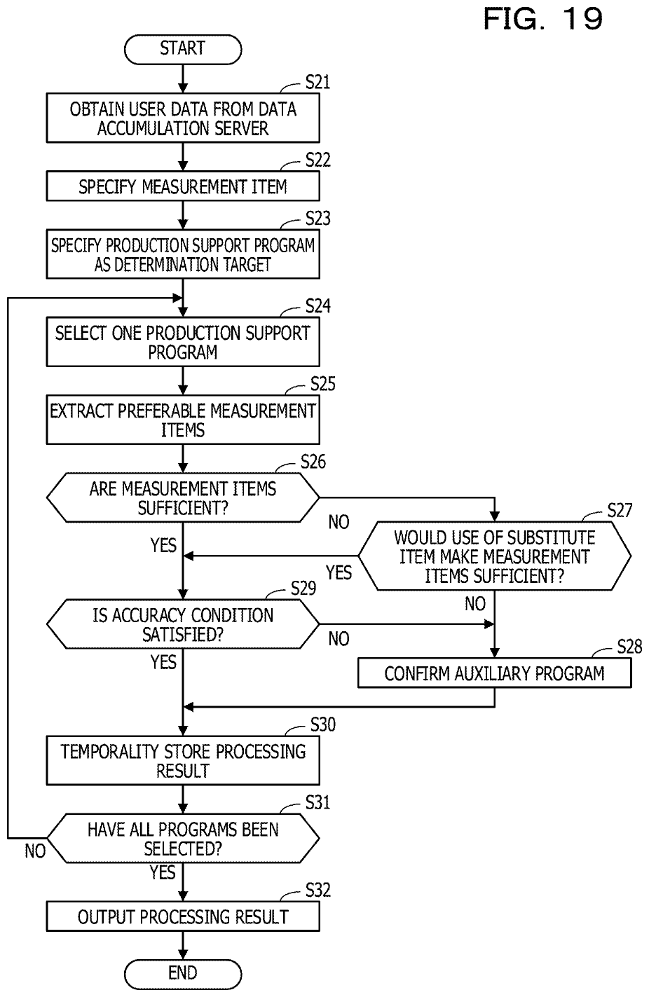

FIG. 19 is a flowchart illustrating a second processing example of the utilization support service. This second processing example illustrates processing in a utilization support service for the purpose of extracting a production support program usable by a specific user out of a plurality of production support programs and presenting the extracted program to the user.

[Step S21]

Using a procedure similar to step S11 in FIG. 17, the utilization support processing part 324 selects a service providing target user and obtains production management data corresponding to the selected user from the data accumulation server 200 via the data acquisition part 323.

[Step S22]

Using a procedure similar to step S12 in FIG. 17, the utilization support processing part 324 specifies the measurement item measured by the production management server 110 of the user.

[Step S23]

The utilization support processing part 324 specifies one or more production support programs to be a determination target in step S24 and subsequent steps, from among the production support programs. For example, the utilization support processing part 324 designates an attribute and thereby specifies a production support program corresponding to the attribute. Examples of the attribute may include an attribute that indicates which types of technology the production support program is applied to, or what types of effects are obtained by the execution of the production support program.

In a case where the user has already received the production support service, this step S22 specifies a production support program other than the production support program currently being used by the user, on the basis of the user management database 313.

[Step S24]

The utilization support processing part 324 selects one production support program as a processing target from among the production support programs specified in step S23.

[Steps S25 to S29]

The utilization support processing part 324 executes the processing similar to the processing of steps S14 to S18 in FIG. 17 with the production support program selected in step S24 set as the processing target.

[Step S30]

The utilization support processing part 324 temporarily stores the processing results of steps S24 to S29 in the storage region. The processing result indicates whether the user can use the production support program selected in step S24. Moreover, in a case where the program may not be used by the user, the processing result further indicates whether addition of new measurement items or improvement of accuracy of measurement values of preferable measurement item would enable the user to use the production support program selected in step S24. Furthermore, in a case where the measurement items are insufficient, the processing result indicates whether there is an auxiliary program for creating a measurement value of the measurement item.

[Step S31]

The utilization support processing part 324 determines whether all the production support programs specified in step S23 have been selected as processing targets. In a case where all the programs have been selected, the utilization support processing part 324 executes the processing of step S32. In contrast, in a case where there is an unselected production support program, the utilization support processing part 324 executes the processing of step S24 and selects the unselected production support program.

[Step S32]

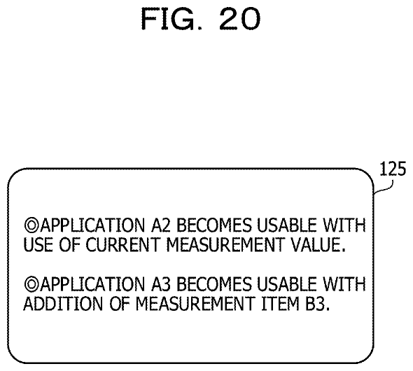

The utilization support processing part 324 creates a final processing result on the basis of the processing result stored in step S30, transmits the processing result to the production management server 110 of the user and controls to display the processing result on the terminal device 120. Here, an example of the processing result is illustrated in FIG. 20.

FIG. 20 is a view illustrating an example of screen display on a terminal device in the second processing example. A screen 125 illustrated in FIG. 20 indicates that the user can use the production support program “application A2” by using the measurement item currently measured. By supplying such information to the user, it is possible to present the user with a production support program that matches the environment of the production facility and production system on the user side. Furthermore, the screen 125 indicates that another production support program “application A3” can be used by newly measuring a measurement item B3. Supplying such information to the user can promote the use of the production support program.

### Third Embodiment

In the second embodiment described above, whether the user can use the production support program is determined on the basis of the preferable measurement items preliminarily registered in the application management database 314. However, not all preferable measurement items preliminarily registered are referred to at actual execution of the production support program. This would lead to erroneous determination that the user may not use the production support program in a case where the production management server 110 of the user has not measured the measurement value of the preferable measurement item that is not actually used. This would result in a failure to supply, to the user, a production support program having a high possibility of actually being used by the user, leading to loss of opportunity to have the production support program be used by the user. This would be disadvantages for both on the service provider side and the user side.

Therefore, in the third embodiment, the processing of the production support server 300 of the second embodiment is modified as follows. The production support server of the third embodiment accumulates history information regarding measurement items used at execution of the production support program. Subsequently, in recommendation of a production support program to the user, the production support server uses the measurement items actually used from the history information as preferable measurement items and determines whether the production support program is usable by the user.

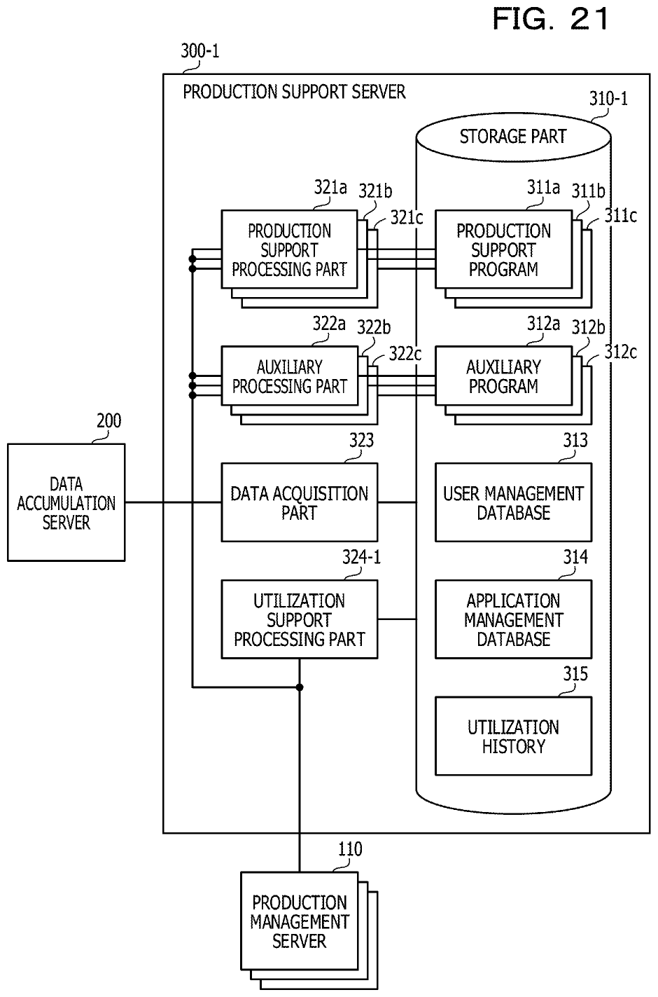

FIG. 21 is a diagram illustrating a configuration example of processing functions provided in a production support server according to the third embodiment. In FIG. 21, same components as in FIG. 8 are denoted by same reference numerals.

A production support server 300-1 illustrated in FIG. 21 includes a storage part 310-1 instead of the storage part 310 illustrated in FIG. 8. In addition to the information stored in the storage part 310, a utilization history 315 is stored in the storage part 310-1. The utilization history 315 registers a history of measurement items used (referred to) by the production support processing parts 321a, 321b, 321c, . . . at execution of the measurement items used (for example, referred to) by the production support programs 311a, 311b, 311c.

Furthermore, the production support server 300-1 includes a utilization support processing part 324-1 instead of the utilization support processing part 324 of FIG. 8. The utilization support processing part 324-1 determines the preferable measurement items corresponding to the production support program on the basis of the utilization history 315, and then determines whether the user can use the production support program by using the determined preferable measurement items.

The processing of the utilization support processing part 324-1 is implemented, for example, by execution of a predetermined program by a processor included in the production support server 300-1.

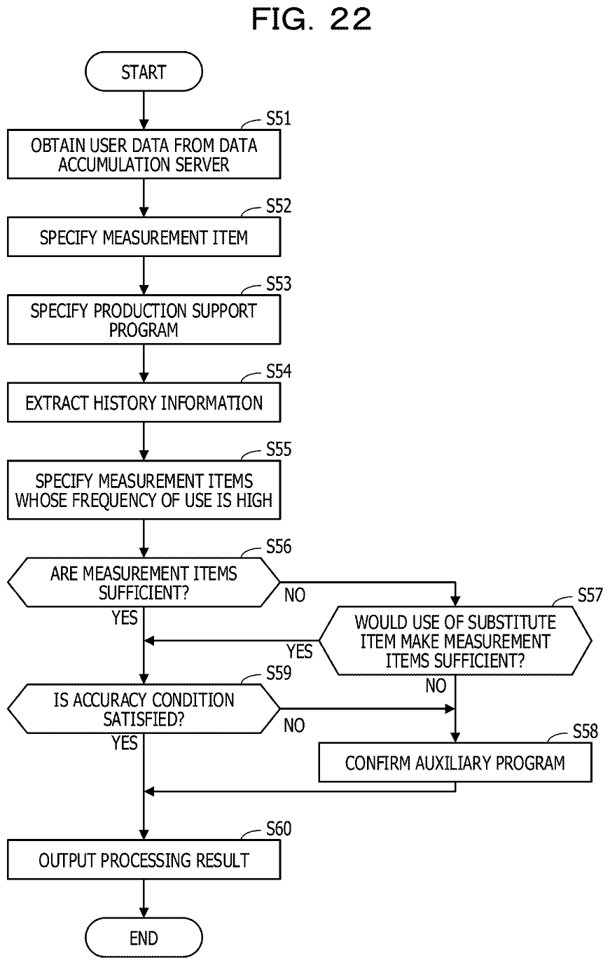

FIG. 22 is a flowchart illustrating an example of processing in the production support service.

[Steps S51 to S53]

The utilization support processing part 324-1 executes processing similar to the processing of steps S11 to S13 in FIG. 17.

[Step S54]

The utilization support processing part 324-1 extracts, from the utilization history 315, history information registered at the time of execution of the production support program specified in step S53. This processing extracts history information registered when a production support service to other users is provided.

[Step S55]

On the basis of the extracted utilization history, the utilization support processing part 324-1 specifies a measurement item whose frequency of use is a certain value or more as a preferable measurement item from among the measurement items that have been used.

Note that this step S55 may be skipped. In this case, the preferable measurement items used in steps S56 to S59 are all the measurement items included in the history information extracted in step S54.

[Step S56 to S59]

The utilization support processing part 324-1 executes processing similar to the processing of steps S15 to S18 in FIG. 17 by using the preferable measurement item specified in step S55.

[Step S60]

In a procedure similar to the procedure of step S19 in FIG. 17, the utilization support processing part 324-1 transmits the processing result of the above processing to the production management server 110 of the user and controls to display the processing result to be displayed on the terminal device 120.

According to the above third embodiment, the measurement item actually used at the time of execution of the production support program is used as a preferable measurement item, and determination is made whether this production support program is usable by the user, or how the production support program can be made usable. This enables determination correct and suitable for actual use state of the measurement value.

### Fourth Embodiment

As described above, the preferable measurement items preliminarily registered in the application management database 314 might not all be referred to at actual execution of the corresponding production support program. As opposed to this, there might be cases where the measurement items set as other measurement items include a measurement item whose frequency of use in practice is high and thus which is considered to be more useful to be set as a preferable measurement item.

Accordingly, a fourth embodiment provides the following developer support service for a developer of the production support program. In this service, unnecessary measurement items and measurement items to be newly added as preferable measurement items among the preferable measurement items set for the production support program are notified to the developer on the basis of the actual utilization status of the production support program.

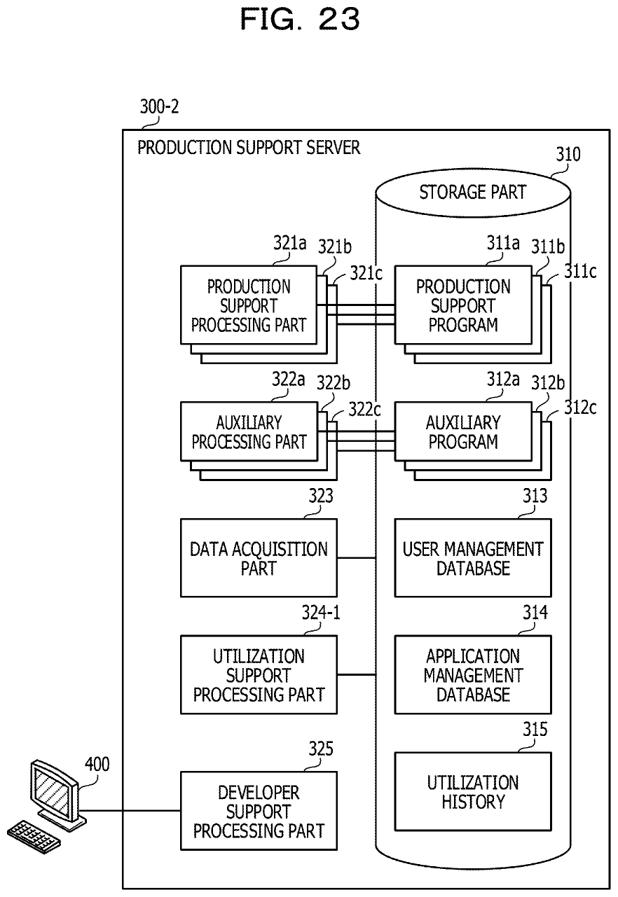

FIG. 23 is a diagram illustrating a configuration example of processing functions provided in a production support server according to the fourth embodiment. In FIG. 23, the same components as in FIG. 21 are denoted by the same reference numerals.

A production support server 300-2 illustrated in FIG. 23 further includes a developer support processing part 325 in addition to the processing functions of the production support server 300-1 in FIG. 21. The developer support processing part 325 is connected to a developer terminal 400 operated by a developer of a production support program. The developer support processing part 325 extracts history information registered at the time of execution of a certain production support program from the utilization history 315, and calculates the frequency of use of the measurement item on the basis of the extracted history information. On the basis of the calculated frequency of use, the developer support processing part 325 determines whether there is an unnecessary measurement item in the preferable measurement items set for the production support program or whether there is a measurement item to be added as a preferable measurement item. Subsequently, the developer support processing part 325 transmits the determination result to the developer terminal 400, and notifies the developer of the determination result.

The processing of the developer support processing part 325 is implemented, for example, by execution of a predetermined program by a processor included in the production support server 300-2.

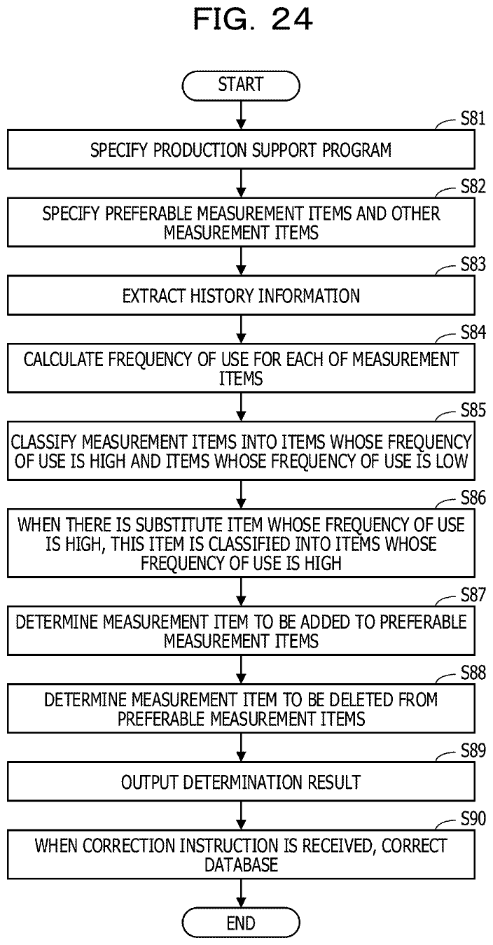

FIG. 24 is a flowchart illustrating a processing example in a developer support service.

[Step S81]

The developer support processing part 325 specifies a production support program as a processing target.

[Step S82]

The developer support processing part 325 refers to the application management database 314 and specifies preferable measurement items set for the production support program specified in step S81 and other measurement items.

[Step S83]

The developer support processing part 325 extracts, from the utilization history 315, history information registered at the time of execution of the production support program specified in step S81.

[Step S84]

On the basis of the extracted history information, the developer support processing part 325 specifies a measurement item used at execution of the production support program specified in step S81. Subsequently, the developer support processing part 325 calculates the frequency of use for each of the specified measurement items. The frequency of use is calculated, for example, by dividing the number of times the measurement data of the measurement item has been referred to by the time of execution of the production support program.

[Step S85]

The developer support processing part 325 classifies the measurement items specified in step S84 into measurement items whose frequency of use is high and measurement items whose frequency of use is low. This classification is performed by comparison of the frequency of use with a predetermined threshold. It is determined that the frequency of use is high in a case where the frequency of use is the threshold or more, and determined that the frequency of use is low in a case where the frequency of use is less than the threshold.

[Step S86]

The developer support processing part 325 refers to the application management database 314 and extracts the measurement item for which the substitute item has been set from among the measurement items determined as those of a low frequency of use in step S85. In a case where the measurement item for which the substitute item has been set is extracted and the use frequency of the substitute item that has been set exceeds the above threshold, the developer support processing part 325 re-classifies the measurement item into the measurement items whose frequency of use is high.

According to the processing of step S86, even in a case where the actual frequency of use of the measurement item set as a preferable measurement item is low, the original measurement item remains to be a preferable measurement item in a case where the frequency of use of the corresponding substitute item is high.

[Step S87]

The developer support processing part 325 extracts measurement items not included in the preferable measurement items specified in step S82, from among the measurement items determined as those of a high frequency of use in steps S85 and S86. The developer support processing part 325 determines that the extracted measurement item is a measurement item to be added to the preferable measurement item.

[Step S88]

The developer support processing part 325 extracts the measurement items determined as those of a low frequency of use in steps S85 and S86 from among the preferable measurement items specified in step S82. The developer support processing part 325 determines that the extracted measurement item is a measurement item to be deleted from the preferable measurement item.

[Step S89]

The developer support processing part 325 transmits the determination results in steps S87 and S88 to the developer terminal 400 and controls to display the determination results on the developer terminal 400.

[Step S90]

In a case where correction of the application management database 314 is requested from the developer terminal 400 by the developer's operation on the terminal, the developer support processing part 325 corrects the application management database 314 on the basis of the determination results in steps S87 and S88

For example, the developer support processing part 325 specifies a record corresponding to the production support program specified in step S81 among the records of the application management database 314. The developer support processing part 325 deletes the measurement item determined as that to be deleted in step S88 among the preferable measurement items registered in the specified record, and adds this measurement item as an item of other measurement items. In addition, the developer support processing part 325 adds the measurement item determined as that to be added in step S87 to the specified record as a preferable measurement item, and deletes this measurement item from the other measurement items.

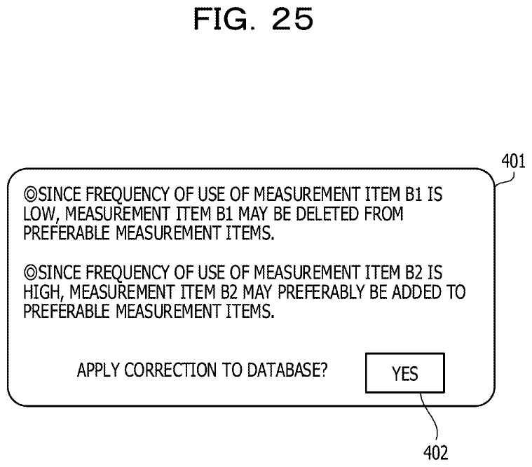

FIG. 25 is a diagram illustrating an example of screen display on a developer terminal by the developer support service. The screen 401 in FIG. 25 illustrates a case where the measurement item B1 has been determined as that to be deleted from the preferable measurement items in step S88 of FIG. 24 and where the measurement item B2 has been determined as that to be added as a preferable measurement item in step S87. This screen 401 is used to notify the developer of the measurement item to be deleted from the preferable measurement item and the measurement item to be added as the preferable measurement item, as a result of an analysis of the data utilization status at the time of execution of the production support program. The developer can effectively use the notified information in developing a future production support program and in maintenance of the current production support service. Accordingly, the processing by the developer support processing part 325 can improve the development efficiency of the developer and the maintenance work efficiency.

Furthermore, the screen 401 includes a display of a button 402 for requesting correction of the application management database 314. By the operation of selecting the button 402 by the developer, the correction of the application management database 314 is requested to the production support server 300-2. In response to this request, the processing of step S90 of FIG. 24 is executed, and the information of the preferable measurement items and other measurement items is updated among the records of the corresponding production support program.

This configuration makes it possible to selectively register data items having high possibility to be actually used at the time of execution of the production support program as preferable measurement items, leading to achieving proper use conditions of the production support program that match the usage status of the user. As a result, the user who can benefit from the use of the production support program will have a high probability of using the production support program, leading to promotion of the use of the program.

Alternatively, for example, a screen that has omitted the button 402 from the screen 401 may be displayed on the terminal device of an administrator of the production support program. In this case, the administrator can perform the setting change operation of the application management database 314 on the basis of the displayed screen.

The processing functions of the apparatuses (for example, the program utilization support device 1 and the production support servers 300, 300-1, and 300-2) described in the above embodiments can be implemented by a computer. In that case, a program describing the processing content of the function that may be included in each of devices is supplied, and the above processing function is implemented on the computer by executing the program on the computer. The program describing the processing content can be recorded on a computer readable recording medium. Examples of the computer-readable recording medium include a magnetic storage device, an optical disc, a magneto-optical recording medium, and a semiconductor memory. Examples of the magnetic storage device include a hard disk drive (HDD), a flexible disk (FD), and a magnetic tape. Examples of the optical disc include a digital versatile disc (DVD), a DVD-RAM, a compact disc-read only memory (CD-ROM), and a CD-recordable (R)/rewritable (RW). An example of a magneto-optical recording medium is a magneto-optical (MO) disk.

Distribution of the program is performed by selling a portable recording medium such as DVDs and CD-ROMs in which the program is recorded. Alternatively, the program may be stored in a storage device of a server computer, and the program may be transferred from the server computer to another computer via a network.

The computer that executes the program stores, in its own storage device, a program recorded on a portable recording medium or a program transferred from the server computer. Subsequently, the computer reads the program from its storage device and executes processing according to the program. The computer can also read the program directly from the portable recording medium and can execute processing according to the program. The computer can also execute processing according to the received program every time the program is transferred from the server computer connected via a network.

The above has described a principle of the present invention. Furthermore, numerous modifications and variations can be made by those skilled in the art. The present invention is not limited to the exact configuration and application example illustrated and described above, and all corresponding variations and equivalents are regarded within the scope of the present invention by appended claims and equivalents thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program utilization support program that causes a computer to execute processing comprising:
obtaining first data items included in production management data;
specifying second data items which are used in execution of a production support program with reference to a storage that stores information indicating an execution status of the production support program; and
determining whether the production support program is usable based on whether all of the second data items are included in the first data items.

2. The non-transitory computer-readable recording medium according to claim 1,
wherein the specifying includes specifying data items whose frequency of use exceeds a predetermined reference value among the data items which are used in the execution of the production support program, as the second data items.

3. The non-transitory computer-readable recording medium according to claim 1, wherein the processing further includes:
calculating an index value indicating accuracy of data values corresponding to the first data items on a basis of the production management data,
wherein a condition that the calculated index value satisfies an index value standard of accuracy which is set for the first data items is included in a condition to determine usability of the production support program.

4. The non-transitory computer-readable recording medium according to claim 3,
wherein the index value indicates acquisition frequency of data values corresponding to an identical data item or a degree of variation of data values corresponding to an identical data item.

5. The non-transitory computer-readable recording medium according to claim 1,
wherein the determining includes determining that the production support program is usable when a fourth data item that substitutes for a third data item out of the second data items is set for the third data item and the third data item is not included in the first data items, and in a case where the first data items include the fourth data item, and data items other than the third data item out of the second data items are all included in the first data items.

6. The non-transitory computer-readable recording medium according to claim 1, wherein the processing further includes:
specifying a data item that is missing or a data item to be added for use the production support program based on a difference between the first data items and the second data items in a case where at least a part of the second data items is not included in the first data items.

7. The non-transitory computer-readable recording medium according to claim 1,
wherein the processing further includes:
in a case the second data items are all included in the first data items, and in a case where a reference value regarding the accuracy of the data value is set to the third data item out of the second data items, and the index value of the accuracy of the data value corresponding to the third data item obtained from the production management data does not satisfy the reference value, outputting information indicating that enhancing accuracy of the data value for the third data item enables utilization of the production support program.

8. An information processing device comprising:
a memory; and
a processor coupled to the memory and configured to execute processing of:
obtaining first data items included in production management data;
specifying second data items which are used in execution of the production support program with reference to a storage that stores information indicating an execution status of the production support program; and
determining whether or not the production support program is usable based on whether or not all of the second data items are included in the first data items.

9. The information processing device according to claim 8,
wherein the specifying includes specifying data items whose frequency of use exceeds a predetermined reference value among the data items which are used in the execution of the production support program, as the second data items.

10. The information processing device according to claim 8, wherein the processing further includes:
calculating an index value indicating accuracy of data values corresponding to the first data items on a basis of the production management data,
wherein a condition that the calculated index value satisfies an index value standard of accuracy which is set for the first data items is included in a condition to determine usability of the production support program.

11. The information processing device according to claim 8,
wherein the determining includes determining that the production support program is usable when a fourth data item that substitutes for a third data item out of the second data items is set for the third data item and the third data item is not included in the first data items, and in a case where the first data items include the fourth data item, and data items other than the third data item out of the second data items are all included in the first data items.

12. The information processing device according to claim 8, wherein the processing further includes:
specifying a data item that is missing or a data item to be added for use the production support program based on a difference between the first data items and the second data items in a case where at least a part of the second data items is not included in the first data items.

13. The information processing device according to claim 8,
wherein the processing further includes:
in a case the second data items are all included in the first data items, and in a case where a reference value regarding the accuracy of the data value is set to the third data item out of the second data items, and the index value of the accuracy of the data value corresponding to the third data item obtained from the production management data does not satisfy the reference value, outputting information indicating that enhancing accuracy of the data value for the third data item enables utilization of the production support program.

14. A program utilization support method comprising:
obtaining, by a computer, first data items included in production management data;
specifying second data items which are used in execution of a production support program with reference to a storage that stores information indicating an execution status of the production support program; and
determining whether or not the production support program is usable based on whether or not all of the second data items are included in the first data items.

15. The program utilization support method according to claim 14,
wherein the specifying includes specifying data items whose frequency of use exceeds a predetermined reference value among the data items which are used in the execution of the production support program, as the second data items.

16. The program utilization support method according to claim 14, further comprising:
calculating an index value indicating accuracy of data values corresponding to the first data items on a basis of the production management data,
wherein a condition that the calculated index value satisfies an index value standard of accuracy which is set for the first data items is included in a condition to determine usability of the production support program.

17. The program utilization support method according to claim 14,
wherein the determining includes determining that the production support program is usable when a fourth data item that substitutes for a third data item out of the second data items is set for the third data item and the third data item is not included in the first data items, and in a case where the first data items include the fourth data item, and data items other than the third data item out of the second data items are all included in the first data items.

18. The program utilization support method according to claim 14, further comprising:
specifying a data item that is missing or a data item to be added for use the production support program based on a difference between the first data items and the second data items in a case where at least a part of the second data items is not included in the first data items.

19. The program utilization support method according to claim 14, further comprising:
in a case the second data items are all included in the first data items, and in a case where a reference value regarding the accuracy of the data value is set to the third data item out of the second data items, and the index value of the accuracy of the data value corresponding to the third data item obtained from the production management data does not satisfy the reference value, outputting information indicating that enhancing accuracy of the data value for the third data item enables utilization of the production support program.
